(19) United States
(12) Patent Application Publication
(10) Pub. No.: US 2011/0292966 A1
(43) Pub. Date: Dec. 1, 2011

(54) TEMPERATURE SENSOR FOR FLEXIBLE CIRCUIT

(75) Inventors: JUSTIN DENNIS PICKEL, HARRISBURG, PA (US); STEVEN J. MILLARD, MECHANICSBURG, PA (US)

(73) Assignee: TYCO ELECTRONICS CORPORATION, BERWYN, PA (US)

(21) Appl. No.: 12/790,272

(22) Filed: May 28, 2010

(51) Int. Cl. G01K 13/00; G01K 7/02; G01K 7/16; G01K 7/00

(52) U.S. Cl. 374/152; 374/163; 374/179; 374/183; 374/E13.001; 374/E07.001; 374/E07.018; 374/E07.004

(57) ABSTRACT

A flexible circuit configured to electrically couple circuit boards is provided. The flexible circuit includes opposite circuit board mating ends and a flexible body extending therebetween. Conductive pathways extend along the body of the flexible circuit to electrically couple the circuit boards. The flexible circuit also includes a temperature sensing circuit including leads having a distal end coupled to a temperature sensor and a temperature contact located proximate to one of circuit board mating ends. The temperature sensor is located at an intermediate position along the body between the circuit board mating ends. The temperature contact is configured to deliver temperature signals from the temperature sensor representative of a local flexible circuit temperature.

### BACKGROUND OF THE INVENTION

The subject matter herein relates generally to flexible circuits, and more particularly, to a system for measuring the temperature of a flexible circuit.

Connector assemblies are used in a number of applications, such as servers, routers, and data storage systems for transmitting signals and/or power through an electrical system. Connector assemblies typically include a backplane or a midplane circuit board, a motherboard, and a plurality of daughter cards. The connector assemblies also include one or more electrical connectors that are attached to the circuit board for interconnecting the daughter cards to the circuit board when the daughter card is inserted into the electrical system. A flexible circuit may be electrically coupled to the daughter cards and the circuit board to transfer power and data signals therebetween. The electrical system includes components coupled to the circuit boards. The flexible circuit transmits signals and/or power between the components of the electrical system. Electrical systems have been proposed that utilize temperature sensors to monitor a temperature of the components or to monitor the temperature of the circuit boards and daughter cards. Based on the temperature of the components or circuit boards, the system determines the integrity of the components in the system.

However, conventional temperature sensor configurations experience certain limitations. Generally, the flexible circuit includes conductive pathways formed from thin copper. During operation, power and/or data signals are sent over the conductive pathways of the flexible circuit. Operation of the electrical system may generate a substantial amount of heat in the flexible circuit. The flexible circuit may overheat because of a limited thickness of the copper conductive pathways. The heat generated in the flexible circuit is distinct and independent from heat generated by the circuit board and the components. Thus, the heat in the flexible circuit may be overlooked if the temperature of the circuit board remains stable. The heat in the flexible circuit may result in damage to the conductive pathways and/or the flexible substrate that may cause the electrical system to malfunction and/or become damaged.

Accordingly, there is a need for an electrical connector assembly capable of monitoring a temperature of the flexible circuit.

### SUMMARY OF THE INVENTION

In one embodiment, a flexible circuit configured to electrically couple circuit boards is provided. The flexible circuit includes opposite circuit board mating ends and a flexible body extending therebetween. Conductive pathways extend along the body of the flexible circuit to electrically couple the circuit boards. The flexible circuit also includes a temperature sensing circuit that includes leads having a distal end coupled to a temperature sensor and a temperature contact located proximate to one of circuit board mating ends. The temperature sensor is located at an intermediate position along the flexible circuit body between the circuit board mating ends. The temperature contact is configured to deliver temperature signals from the temperature sensor representative of a local flexible circuit temperature.

In another embodiment, a removable card connector assembly is provided. The assembly includes a circuit board and a connector coupled to the circuit board and configured to couple the assembly to another circuit board. A flexible circuit electrically couples the circuit boards. The flexible circuit includes opposite circuit board mating ends and a flexible body extending therebetween. Conductive pathways extend along the body of the flexible circuit to electrically couple the circuit boards. The flexible circuit also includes a temperature sensing circuit including leads having a distal end coupled to a temperature sensor and a temperature contact located proximate to one of circuit board mating ends. The temperature sensor is located at an intermediate position along the body between the circuit board mating ends. The temperature contact is configured to deliver temperature signals that are distinct and independent from a temperature of the circuit boards.

In another embodiment, an electrical system is provided. The electrical system includes circuit boards and a connector configured to couple the circuit boards. A flexible circuit electrically couples the circuit boards. A temperature sensing circuit is provided that includes leads having a distal end coupled to a temperature sensor and a temperature contact located proximate to an end of the flexible circuit. The temperature sensor is located at an intermediate position along the flexible circuit between ends of the flexible circuit. The temperature contact is configured to deliver temperature signals from the temperature sensor representative of a local flexible circuit temperature.

### BRIEF DESCRIPTION OF THE DRAWINGS

FIG. 1 is a perspective view of an electrical system formed in accordance with an embodiment.

FIG. 2 is a plan view of a flexible circuit formed in accordance with an embodiment.

FIG. 3 is a plan view of an embodiment of the flexible circuit shown in FIG. 2.

FIG. 4 is a plan view of a flexible circuit formed in accordance with another embodiment.

FIG. 5 is a plan view of a flexible circuit formed in accordance with another embodiment.

FIG. 6 is a cross-sectional view of a flexible circuit formed in accordance with an embodiment.

FIG. 7 is a cross-sectional view of a flexible circuit formed in accordance with another embodiment.

FIG. 8 is a cross-sectional view of a flexible circuit formed in accordance with another embodiment.

FIG. 9 is a cross-sectional view of a flexible circuit formed in accordance with another embodiment.

### DETAILED DESCRIPTION OF THE DRAWINGS

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

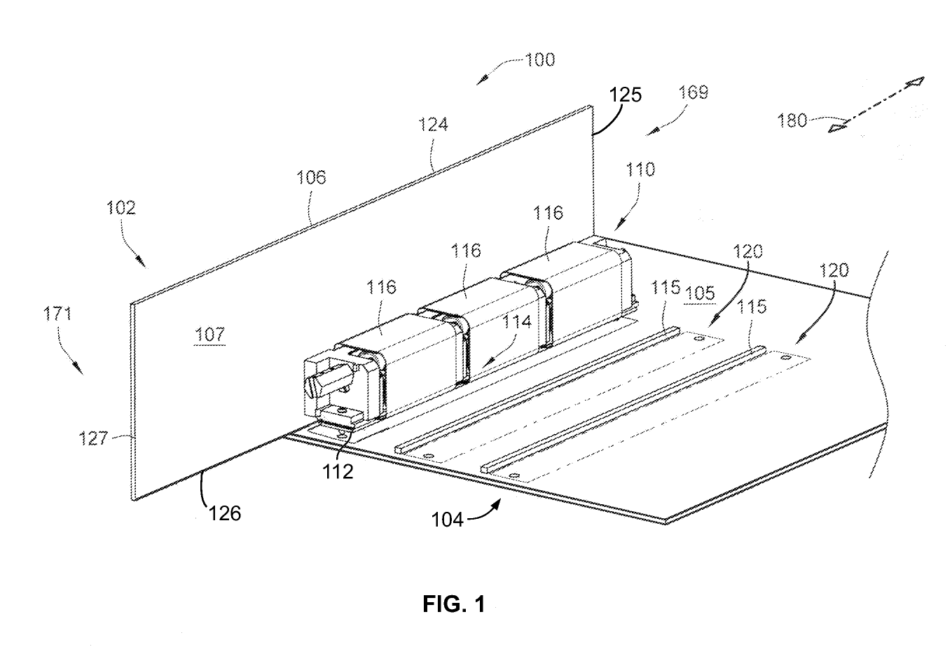

FIG. 1 is a perspective view of an electrical system 100 formed in accordance with one embodiment that includes a removable card connector assembly 102 and a primary circuit board 104. The card connector assembly 102 includes a secondary circuit board 106 having a surface 107 and an electrical connector assembly 110 that is coupled to the surface 107 of the secondary circuit board 106. The card connector assembly 102 has a leading end 169 and a trailing end 171, and the secondary circuit board 106 is defined by side edges 124, 125, 126, and 127. The electrical connector assembly 110 is configured to be removably coupled to a system contact array 120 of mating contacts along a surface 105 of the primary circuit board 104. As one example for the electrical system 100, the card connector assembly 102 may be a part of a server blade and the primary circuit board 104 may be a mother board of a server system. However, the electrical system 100 shown in FIG. 1 may be a variety of other electrical systems, such as a router system or data storage system.

The electrical connector assembly 110 includes a circuit assembly 114 having a mating side 112 and one or more flexible circuits 116. The circuit assembly 114 communicatively couples the primary and secondary circuit boards 104 and 106 by providing conductive paths therebetween. The mating side 112 may also include one or more moveable contact arrays that are configured to be moved toward and away from the contact array 120 of mating contacts on the primary circuit board 104.

When the card connector assembly 102 and the primary circuit board 104 are to be engaged, the card connector assembly 102 may be advanced along the surface 105 in a longitudinal mating direction (i.e., along a longitudinal axis 180). For example, the card connector assembly 102 may slidably engage guiding features 115, which are illustrated as rails in FIG. 1, and slide to a predetermined position and orientation with respect to the contact array 120. Once the card connector assembly 102 is properly positioned alongside the contact array 120, the mating side 112 may be moved to engage the contact array.

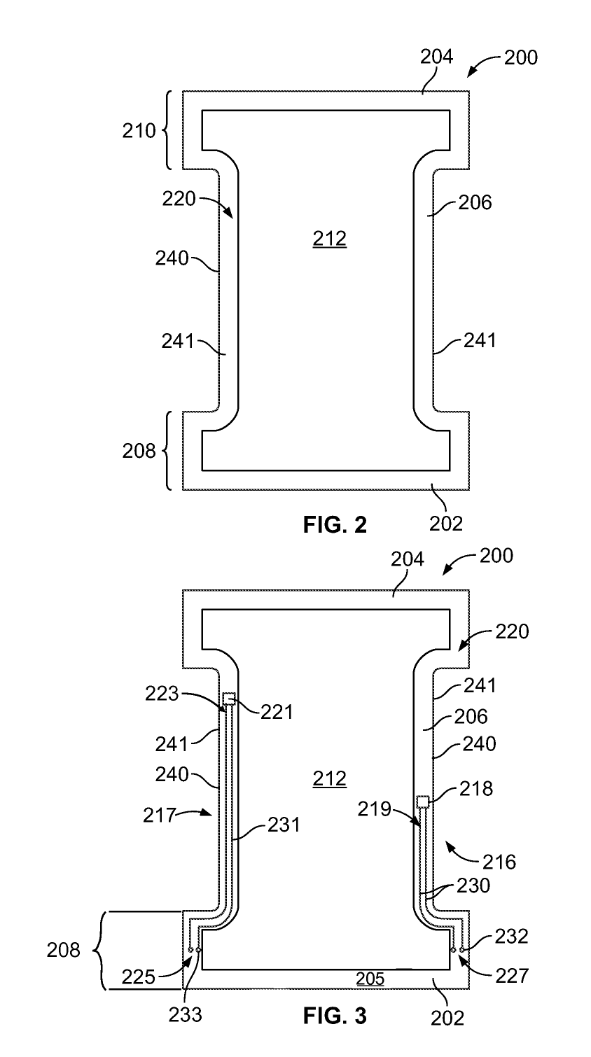

As will be discussed in greater detail below, embodiments are described herein that are configured to reduce overheating of, and damage to, the flexible circuit 116. In accordance with certain embodiments, structure is provided to enable the electrical connector assembly 110 to measure a temperature of the flexible circuit 116, as described in FIGS. 2-4.

FIG. 2 is a plan view of a flexible circuit 200 that may be used in accordance with an embodiment. The flexible circuit 200 may be used in place of the flexible circuit 116, shown in FIG. 1. The flexible circuit 200 includes a pair of circuit board mating ends 202 and 204. The circuit board mating ends 202 and 204 are formed from a rigid material and are configured to couple to one of a pair of circuit boards. A flexible body 206 extends between the circuit board mating ends 202 and 204. The flexible body 206 may be formed from a flexible polymer film, for example polyester, polyimide, polyethylene napthalate, and/or polyetherimide. A thickness of the flexible body 206 is proportional to a flexibility of the flexible body 206. The flexible body 206 includes a pair of sides 241 and a midpoint 240 centered between the circuit board mating end 202 and the circuit board mating end 204. The circuit board mating end 202 includes an interface 208 that is configured to couple to a circuit board, for example primary circuit board 104, shown in FIG. 1. The circuit board mating end 204 includes an interface 210 that is configured to couple to another circuit board, for example secondary circuit board 106.

The interfaces 208 and 210 may be configured to be inserted into a slot of the circuit board 104, 106 and/or include contacts that are through hole mounted to the circuit board 104. 106. Optionally, the interfaces 208 and 210 may include vias to receive contacts extending from the circuit board 104, 106. In another embodiment, the interfaces 208 and 210 may include pads that are soldered and/or otherwise mechanically coupled to the circuit board 104, 106 or the circuit board 104, 106 may include pads to which the interfaces 208 and 210 are mechanically coupled.

A conductive pathway 212 extends through the flexible body 206. The conductive pathway 212 is formed from a metal foil, for example copper. Alternatively, the conductive pathway 212 may be formed from any suitable conductive material. The conductive pathway 212 may be a power trace that carries power across the flexible circuit 200 between the circuit boards 104 and 106. Optionally, the conductive pathway 212 may be a signal trace that carries data signals between the circuit boards 104 and 106. In one embodiment, the conductive pathway 212 is embedded within the flexible body 206, as illustrated in FIGS. 7-10. Alternatively, the conductive pathway 212 may extend along a surface 220 of the flexible circuit 200. In one embodiment, the flexible circuit 200 may include multiple conductive pathways 212. The flexible circuit 200 may also include multiple power traces and signal traces. A protective covering may extend over the flexible circuit 200 to protect the conductive pathway 212 extending there along.

FIG. 3 illustrates the flexible circuit 200 having temperature sensing circuits 216 and 217 coupled thereto. The temperature sensing circuits 216 and 217 may be provided on the surface 220 of the flexible circuit 200, embedded within the flexible circuit 200 or both. In an embodiment having a protective covering, the temperature sensing circuits 216 and 217 may be positioned above or below the protective covering. The temperature sensing circuit 216 includes a pair of leads 230 and a temperature sensor 218 connected to a distal end 219 of each lead 230. The leads 230 include a pair of temperature contacts 232 positioned at a proximate end 227 of each lead 230. The temperature sensing circuit 217 includes a pair of leads 231 and a temperature sensor 221 positioned at a distal end 223 of each lead 231. The leads 230 include a pair of temperature contacts 233 positioned at a proximate end 225 of each lead 231. The temperature contacts 232 and 233 are located on or proximate to the mating end 202 of the flexible circuit. When the mating end 202 is joined to a circuit board 104, 106, the temperature contacts 232 and 233 electrically engage mating contacts on the circuit board 104, 106.

The temperature sensors 218 and 221 may be thermocouples that create a voltage difference based on the temperature at the corresponding temperature sensor 218 and 221. Alternatively, the temperature sensors 218 and 221 may be resistive thermal devices, the electrical resistance of which varies based on temperature. In other embodiments, any suitable temperature sensor may be utilized. Alternatively, combinations of temperature sensors may be utilized. The temperature sensing circuits 216 and 217 are configured to measure a local temperature for a region of the flexible circuit 200 immediately adjacent the temperature sensors 218 and 221. In one embodiment, the temperature sensing circuits 216 and 217 measure a local trace temperature of the conductive pathway 212. The trace temperature is indicative of an amount of heat generated by the conductive pathway 212. Alternatively, the temperature sensing circuits 216 and 217 may detect a surrounding temperature of the air adjacent to the flexible body 206. The surrounding temperature is indicative of the heat generated by the flexible circuit 200. The temperature sensing circuits 216 and 217 may also measure a body temperature indicative of the heat imposed on the body of the flexible body 206 by the conductive pathway 212. In one embodiment, the temperature sensing circuits 216 and 217 may detect any combination of the trace temperature, surrounding temperature, and/or body temperature. The temperatures detected by the temperature sensing circuits 216 and 217 are distinct and independent from a temperature of the circuit boards.

In one example, the temperature sensor 218 of the temperature sensing circuit 216 may be positioned along a side of and adjacent to the conductive pathway 212 near the midpoint 240 of the flexible circuit 200. The temperature sensor 218 may be positioned along the length of the flexible circuit 200 at any intermediate location between the circuit board mating end 202 and the midpoint 240. Additionally, the temperature sensor 218 may be positioned laterally outward from the conductive pathway 212 but inside the side 241 of the flexible body 206. The temperature sensor 218 is coupled to the flexible body 206. The temperature sensor 218 may be positioned on the surface 220 of the flexible circuit 200. Alternatively, the temperature sensor 218 may be embedded within the flexible circuit 200. In an embodiment having a protective covering, the temperature sensor 218 may be positioned above or below the protective covering. The shape, size and arrangement of the temperature sensor 218 may vary.

In the exemplary embodiment, the leads 230 of temperature sensing circuit 216 extend from the temperature sensor 218 toward the circuit board mating end 202 of the flexible circuit 200. In an alternative embodiment, the leads 230 may extend toward the circuit board mating end 204. The leads 230 may be positioned on the surface 220 of the flexible circuit 200. Optionally, the leads 230 may be embedded within the flexible circuit 200. The leads 230 may also extend above or below a protective covering. The arrangement of each lead 230 may vary from the arrangement of the other lead 230.

The temperature contacts 232 are positioned proximate to the circuit board mating end 202. Alternatively, the temperature contacts 232 may be positioned proximate the circuit board mating end 204. The temperature contacts 232 may be positioned on a surface 205 of the circuit board mating end 202. Optionally, the temperature contacts 232 may be embedded within the circuit board mating end 202. The temperature contacts 232 may also be positioned above or below a protective covering. The temperature contacts 232 may be aligned with one another or may be misaligned. The spacing between the temperature contacts 232 may also vary. The temperature contacts 232 are electrically coupled to the interface 208 to transmit temperature signals from temperature sensing circuit 216 to a circuit board.

In one example, the temperature sensor 221 of the temperature sensing circuit 217 may be positioned along a side of and adjacent to, the conductive pathway 212 near the circuit board mating end 204 of the flexible circuit 200. The temperature sensor 221 may be positioned along the length of the flexible circuit 200 at any intermediate location between the circuit board mating end 204 and the midpoint 240. Additionally, the temperature sensor 221 may be positioned laterally outward from the conductive pathway 212 but inside the side 241 of the flexible body 206. The temperature sensor 221 may be positioned on the surface 220 of the flexible body 206 or may be embedded within the flexible body 206. The temperature sensor 221 may also be positioned above or below the protective covering. The size, shape and arrangement of the temperature sensor 221 may vary.

FIG. 3 illustrates the temperature sensor 218 positioned between the midpoint 240 and the circuit board mating end 202. Temperature sensor 221 is illustrated between the midpoint 240 and the circuit board mating end 204. It should be noted that both temperature sensors 218 and 221 may be located between the midpoint 240 and the circuit board mating end 202 or between the midpoint 240 and the circuit board mating end 204.

The leads 231 of the temperature sensing circuit 217 extend from the temperature sensor 221 toward the circuit board mating end 202 of the flexible circuit 200. Alternatively, the leads 231 may extend toward the circuit board mating end 204. The leads 231 may be positioned on the surface 220 of the flexible circuit 200 or embedded within the flexible circuit 200. The leads 231 may also extend above or below a protective covering. The arrangement of each lead 231 may vary from the arrangement of the other lead 231.

The temperature contacts 233 are positioned proximate to the circuit board mating end 202. Alternatively, the temperature contacts 233 may be positioned proximate to the circuit board mating end 204. The temperature contacts 233 may be positioned on the surface 205 of the circuit board mating end 202 or embedded within the circuit board mating end 202. The temperature contacts 233 may also be positioned above or below a protective covering. The alignment and spacing of the temperature contacts 233 may also vary. The temperature contacts 233 are electrically coupled to the interface 208 to deliver temperature signals from the temperature sensing circuit 217 to a circuit board 104, 106.

The circuit board 104, 106 receives the temperature signals from the temperature sensing circuits 216, 217 indicative of a local temperature for a region of the flexible circuit 200 adjacent the temperature sensing circuits 216, 217. The local temperature represents one of the trace temperature, surrounding temperature, and body temperature of the flexible circuit 200. The circuit board 104, 106 monitors the temperatures to maintain the integrity of the flexible circuit 200. In one embodiment, the circuit board 104, 106 monitors the temperature signals from both the temperature sensing circuit 216 and the temperature sensing circuit 217. Alternatively, the circuit board 104, 106 may only monitor temperature signals from one of the temperature sensing circuit 216 or temperature sensing circuit 217.

During operation, power and/or data signals are transmitted between the circuit boards 104 and 106 via the conductive pathway 212. The conductive pathway 212 generates heat that may increase the temperature of the flexible circuit 200. The increased temperature may be damaging to either the conductive pathway 212 and/or the flexible body 206. The temperature sensors 218 and 221 of the temperature sensing circuits 216 and 217, respectively, sense a temperature that is indicative of the temperature of one of the conductive pathway 212, the flexible body 206, and/or the air adjacent the flexible circuit 200. A temperature signal is delivered to at least one of the circuit boards via the leads 230 and 231 and the temperature contacts 232 and 233 of the temperature sensing circuits 216 and 217, respectively. The circuit boards 104 and 106 monitor the temperature of the flexible circuit 200 based on the temperature signal to prevent damage to and/or malfunctioning of the flexible circuit 200 and/or the circuit boards 104 and 106.

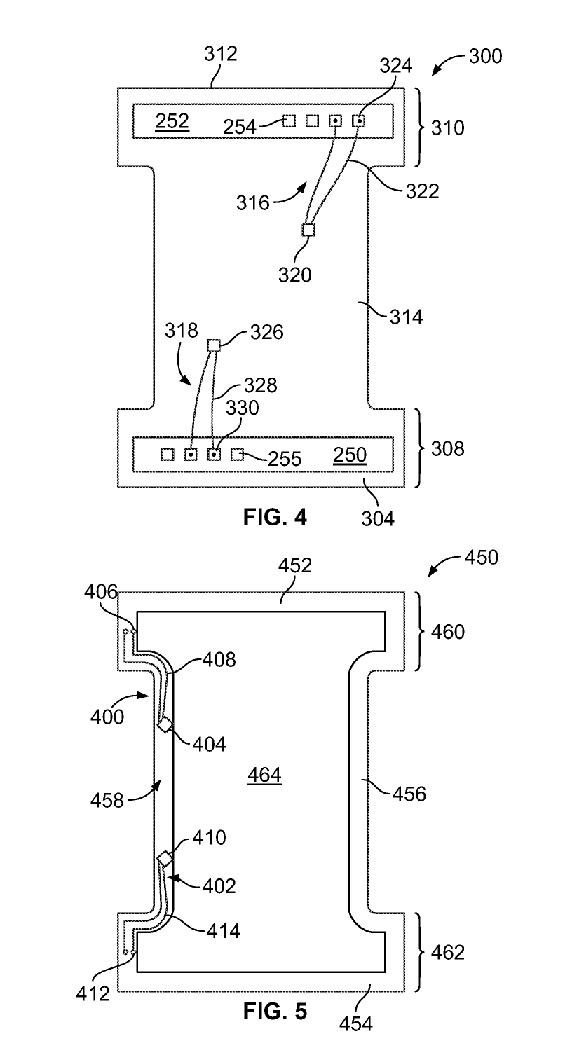

FIG. 4 illustrates a flexible circuit 300 having a pair of circuit board mating ends 304 and 312. A flexible body 314 extends between the circuit board mating ends 304 and 312. The circuit board mating end 304 includes an interface 308 that is configured to couple to one of the circuit boards 104 or 106. The circuit board mating end 312 includes an interlace 310 that is configured to couple to the other of the circuit boards 104 and 106. An electrical footprint 250 is positioned on the circuit board mating end 304. The electrical footprint 250 is electrically coupled to the interface 308. An electrical footprint 252 is positioned on the circuit board mating end 312 and is electrically coupled to the interface 310.

The flexible circuit 300 includes a pair of temperature sensing circuits 316 and 318. The temperature sensing circuit 316 includes a temperature sensor 320 positioned on the flexible body 314 of the flexible circuit 300. A pair of leads 322 extend from the temperature sensor 320 to respective temperature contacts 324. The temperature contacts 324 are positioned proximate to the circuit board mating end 312. The temperature sensing circuit 318 includes a temperature sensor 326 positioned on the flexible body 314. A pair of leads 328 extend from the temperature sensor 326 to respective temperature contacts 330. The temperature contacts 330 are positioned proximate to the circuit board mating end 304.

The footprint 252 includes a plurality of vias 254 that are configured to receive the temperature contacts 324 of the temperature sensing circuit 316. The temperature contacts 324 are positioned within the vias 254. The footprint 252 is positioned flush with one of the circuit boards 104 or 106 to couple the flexible circuit 300 thereto. The circuit board 104, 106 includes a plurality of pins that are configured for through-hole mounting within the vias 254 to electrically couple the circuit board 104, 106 and the flexible circuit 300. The temperature contacts 324 are coupled within the vias 254 and in contact with the pins of the circuit board 104, 106 to electrically couple the temperature sensing circuit 316 to the circuit board 104, 106. Optionally, the temperature contacts 324 may be soldered to the footprint 252 or coupled thereto using any suitable mechanical and electrical coupling. The footprint 252 may be soldered to the circuit board 104, 106 so that an electrical connection is made between the temperature contacts 324 and the circuit board 104, 106. The temperature contacts 324 deliver temperature signals from temperature sensors 320 of the temperature sensing circuit 316 to the circuit board 104, 106 to determine and monitor a temperature of the flexible circuit 300.

The footprint 250 includes a plurality of vias 255 that are configured to receive the temperature contacts 330. The footprint 250 is configured to position flush with the other of the circuit boards 104, 106 to electrically couple the flexible circuit 300 thereto. The footprint 250 receives pins positioned on the circuit board 104, 106. The temperature contacts 330 electrically couple to the pins to electrically couple the temperature sensing circuit 318 to the circuit board 104, 106. The temperature contacts 330 deliver temperature signals from temperature sensors 326 of the temperature sensing circuit 318 to the circuit board 104, 106 to determine and monitor a temperature of the flexible circuit 300.

FIG. 5 illustrates a flexible circuit 450 having a pair of circuit board mating ends 452 and 454. A flexible body 456 extends between the circuit board mating ends 452 and 454, and a surface 458 extends along the flexible circuit 450. The circuit board mating end 452 includes an interface 460 and the circuit board mating end 454 includes and interface 462. A conductive pathway 464 extends through the flexible body 456 to electrically couple the interface 460 and the interface 462. The flexible circuit 450 includes a temperature sensing circuit 400 and a temperature sensing circuit 402. The temperature sensing circuit 400 includes a temperature sensor 404, a pair of temperature contacts 406, and a pair of leads 408 extending between the temperature sensor 404 and temperature contacts 406. The temperature sensing circuit 402 includes a temperature sensor 410, a pair of temperature contacts 412, and a pair of leads 414. The temperature sensing circuits 400 and 402 are configured to measure a local temperature for a region of the flexible circuit 450 immediately adjacent the temperature sensors 400 and 402.

In one example, the temperature sensors 404 and 410 may be provided on the surface 458, embedded within the flexible circuit 450, or both. The temperature sensors 404 and 410 may also be positioned above or below a protective covering. The temperature sensors 404 and 410 may be aligned with one another or may be misaligned. Additionally, a size, shape, and arrangement of the temperature sensor 404 and 410 may vary.

The temperature sensor 404 is positioned proximate to the circuit board mating end 452. Alternatively, the temperature sensor 404 may be coupled adjacent the conductive pathway 464 at any intermediate position between the circuit board mating end 452 and the circuit board mating end 454. The temperature sensor 410 is positioned adjacent the circuit board mating end 454. Optionally, the temperature sensor 410 may be coupled adjacent the conductive pathway 464 at any intermediate position between the circuit board mating end 454 and the circuit board mating end 452.

The leads 408 extend from the temperature sensor 404 toward the circuit board mating end 452. The leads 414 extend from the temperature sensor 410 toward the circuit board mating end 454. The leads 408 and 414 may be positioned on the surface 458 of the flexible circuit 450 and/or embedded therein. The leads 408 and 414 may also extend above or below a protective covering. The arrangement of each lead 408 and 414 may vary from the arrangement of the other lead 408 and 414.

The temperature contacts 412 are coupled to the circuit board mating end 454. The temperature contacts 41.2 are electrically coupled to the interface 462 to deliver temperature signals from the temperature sensing circuit 402 to one of circuit board 104 or 106. The temperature contacts 406 are coupled to the circuit board mating end 452. The temperature contacts 406 are electrically coupled to the interface 460 to deliver temperature signals from the temperature sensing circuit 400 to the other of circuit board 104, 106.

The circuit board 104, 106 receives the temperature signals from the temperature sensing circuit 400 and the other circuit board 104, 106 receives the temperature signals from the temperature sensing circuit 402. At least one of the circuit board 104 and 106 utilize the temperature signals to monitor one of the trace temperature, surrounding temperature, and body temperature of the flexible circuit 450 to maintain the integrity of the flexible circuit 450.

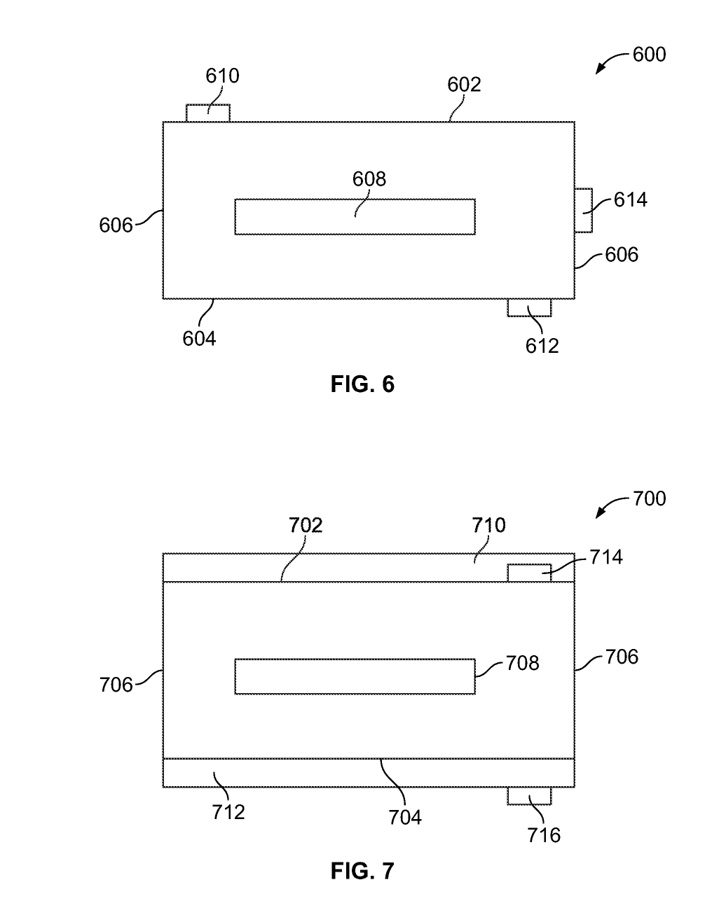

FIG. 6 is a side cross-sectional view of a flexible circuit 600. In an embodiment, FIG. 6 illustrates a cross-sectional view of a flexible body of the flexible circuit 600. Alternatively, FIG. 6 illustrates a cross-sectional view of a circuit board mating end of the flexible circuit 600. The flexible circuit 600 includes a top surface 602 and a bottom surface 604. A pair of side surfaces 606 extend between the top surface 602 and the bottom surface 604. A conductive pathway 608 is embedded within and extends through the flexible circuit 600. Alternatively, a conductive pathway 608 may extend along the top surface 602 or the bottom surface 604. The flexible circuit 600 may also include multiple conductive pathways 608 embedded therein and/or extending along the surfaces 602 and/or 604.

The flexible circuit 600 includes temperature devices 610, 612, and 614. The temperature devices 610, 612, and 614 may represent temperature sensors, leads, and/or temperature contacts. The temperature device 610 is provided on the top surface 602. The temperature device 610 may be provided at any intermediate location of the top surface 602 between the side surfaces 606. For example, the temperature device 610 may be positioned above the conductive pathway 608. The temperature device 612 is provided on the bottom surface 604 of the flexible circuit 600. The temperature device 612 may be provided at any intermediate location of the bottom surface 604 between the side surfaces 606. For example, the temperature device 612 may be provided below the conductive pathway 608. The temperature device 614 is located on the side surface 229. The temperature device 614 may be located at any position between the top surface 602 and the bottom surface 604. The temperature device 614 may be located on either side 606 of the flexible circuit 600.

FIG. 6 illustrates the temperature devices 610, 612, and 614. The flexible circuit 600 may include any one of the temperature devices 610, 612, and 614. Optionally, the flexible circuit 600 may include any combination of the temperature devices 610, 612, and 614. Additionally, the flexible circuit 600 may include any number of temperature devices 610, 612, and 614. For example, the flexible circuit 600 may include multiple temperature devices 610, 612, and 614 on the top surface 602, the bottom surface 604, and/or either side surface 606. The shape, size, and arrangement of the temperature devices 610, 612, and 614 may also vary.

FIG. 7 illustrates a side cross-sectional view of a flexible circuit 700. The flexible circuit 700 includes a top surface 702 and a bottom surface 704. A pair of side surfaces 706 extend between the top surface 702 and the bottom surface 704. A conductive pathway 708 is embedded within and extends through the flexible circuit 700. Alternatively, the flexible circuit 700 may include multiple conductive pathways 708 that are embedded within the flexible circuit 700 and/or extend along the top surface 702 and/or the bottom surface 704. A protective layer 710 extends along the top surface 702 and a protective layer 712 extends along the bottom surface 704. Optionally, a protective layer may extend along the side surface 706. The protective layers 710 and 712 are provided to protect the components of the flexible circuit 700.

The flexible circuit 700 includes temperature devices 714 and 716 provided thereon. The temperature devices 714 and 716 may be any one of a temperature sensor, a lead, and/or a temperature contact. The temperature device 714 is provided on the top surface 702. The temperature device 714 is coupled above the top surface 702 and beneath the protective layer 710. Alternatively, the temperature device 714 may be positioned above, and coupled to, the protective layer 710. The temperature device 716 is positioned externally below, and coupled to, the protective layer 712. Optionally, the temperature device 716 may be coupled between the bottom surface 704 and the protective layer 712. In an embodiment having a protective layer along the side surface 706 of the flexible circuit 700, a temperature device may be positioned either the side surface 706 beneath the protective layer and/or positioned on, and coupled to, the protective layer extending along the side surface 706. The temperature device may also be positioned on either side surface 706 or both side surfaces 706.

FIG. 7 illustrates the temperature devices 714 and 716. The flexible circuit 700 may include any one of the temperature devices 714 and 716. Optionally, the flexible circuit 700 may include any combination of the temperature devices 714 and 716. Additionally, the flexible circuit 700 may include any number of temperature devices 714 and 716. For example, the flexible circuit 700 may include multiple temperature devices 714 and 716 on the top surface 702, the bottom surface 704, and/or either side surface 706. The shape, size, and arrangement of the temperature devices 714 and 716 may also vary. For example, some of the temperature devices 714 and 716 may be positioned above and/or below the protective layer 710, 712.

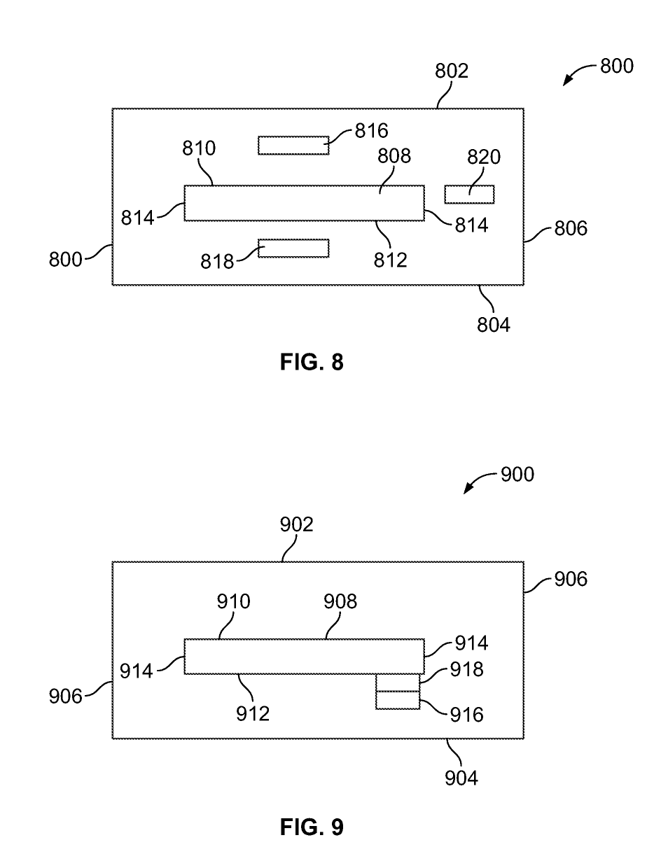

FIG. 8 is a side cross-sectional view of a flexible circuit 800. The flexible circuit 800 includes a top surface 802, a bottom surface 804, and a pair of side surfaces 806 extending between the top surface 802 and the bottom surface 804. A conductive pathway 808 is embedded within and extends through the flexible circuit 800. The conductive pathway 808 includes a top surface 810, a bottom surface 812, and a pair of side surfaces 814 extending between the top surface 810 and the bottom surface 812. Alternatively, the conductive pathway 808 may extend along the top surface 802 and/or the bottom surface 804. The flexible circuit 800 may also include multiple conductive pathways 808 embedded therein and/or extending along the top surface 802 and/or the bottom surface 804.

The flexible circuit 800 includes temperature devices 816, 818, and 820. Temperature devices 816, 818, and 820 may be temperature sensors, leads, and/or temperature contacts. The temperature sensor 816 is embedded between the top surface 810 of the conductive pathway 808 and the top surface 802 of the flexible circuit 800. The temperature device 816 is positioned outward from the conductive pathway 808. The temperature device 816 may be embedded at any intermediate location between the top surface 810 and the top surface 802. The temperature device 818 is embedded within the flexible circuit 800 between the bottom surface 812 of the conductive pathway 808 and the bottom surface 804 of the flexible, circuit 800. The temperature device 818 may be positioned outward from the conductive pathway 808 at any intermediate location between the bottom surface 812 and the bottom surface 804. The temperature device 820 is embedded within the flexible circuit between the side surface 814 of the conductive pathway 808 and the side surface 806 of the flexible circuit 800. The temperature device 820 may be positioned between either side surface 806 and the corresponding side surface 814. The temperature device 820 may be embedded outward from the conductive pathway 808 at any location between the side surface 814 and the side surface 806.

FIG. 8 illustrates the temperature devices 816, 818, and 820. The flexible circuit 800 may include any one of the temperature devices 816, 818, and 820. Optionally, the flexible circuit 800 may include any combination of the temperature devices 816, 818, and 820. The size, shape, and arrangement of the temperature devices 816, 818, and 820 may also vary. Alternatively, the flexible circuit may include any number of temperature devices 816, 818, and 820 embedded outward from any of the top surface 810, the bottom surface 812, and/or the side surfaces 814 of the conductive pathway 808.

FIG. 9 is a side cross-sectional view of a flexible circuit 900. The flexible circuit 900 includes a top surface 902, a bottom surface 904, and a pair of side surfaces 906 extending between the top surface 902 and the bottom surface 904. A conductive pathway 908 extends through the flexible circuit 900. The conductive pathway 908 is illustrated as being embedded within the flexible circuit 900. Alternatively, the conductive pathway 908 may extend along the top surface 902, the bottom surface 904, and/or the side surface 906 of the flexible circuit 900. The flexible circuit 900 may also include multiple conductive pathways 908. The conductive pathway 908 includes a top surface 910, a bottom surface 912, and a pair of side surfaces 914.

A temperature device 916 is provided on the flexible circuit 900. The temperature device 916 may be any of a temperature sensor, a lead, and/or a temperature contact. The temperature device 916 includes an insulative barrier 918. The insulative barrier 918 is formed from any material capable of electrically insulating the temperature device 916. Additionally, the insulative barrier 918 is capable of conducting heat so that the temperature device 916 can monitor a temperature of the flexible circuit 900. The temperature device 916 is positioned on the conductive pathway 908 so that the barrier 918 is positioned between the temperature device 916 and the conductive pathway 908. In an alternative embodiment, the temperature device 916 may be positioned on the top surface 910 and/or the side surface 914 of the conductive pathway 908. Alternatively, the flexible circuit 900 may include any number of temperature devices 916 positioned on the conductive pathway 908.

FIGS. 3-9 illustrate various different embodiments of a flexible circuit having temperature devices. It should be noted that any of these embodiments may be utilized independently or in combination with one another.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first.” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within, the scope of the claims if the examples have structural elements that do not differ from the literal language of the claims, or if the examples include equivalent structural elements with insubstantial differences from the literal languages of the claims.

What is claimed is:

1. A flexible circuit configured to electrically couple circuit boards, the flexible circuit comprising:
opposite circuit board mating ends and a flexible body extending therebetween;
conductive pathways extending along the body of the flexible circuit to electrically couple the circuit boards; and
a temperature sensing circuit comprising leads having a distal end coupled to a temperature sensor and a temperature contact located proximate to one of circuit board mating ends, the temperature sensor located at an intermediate position along the body between the circuit board mating ends, the temperature contact configured to deliver temperature signals from the temperature sensor representative of a local temperature.

2. The flexible circuit of claim 1, wherein the temperature sensor delivers temperature signals that are distinct and independent from a temperature of the circuit boards.

3. The flexible circuit of claim 1, wherein the temperature signals represent at least one of a trace temperature, a body temperature, or a surrounding temperature.

4. The flexible circuit of claim 1, wherein the temperature sensor is positioned adjacent the conductive pathway.

5. The flexible circuit of claim 1, wherein the temperature sensor is a thermocouple that measures a voltage difference.

6. The flexible circuit of claim 1, wherein the temperature sensor is a resistive thermal device that measures an electrical resistance.

7. The flexible circuit of claim 1, wherein the temperature sensor is positioned at least one of above or below the conductive pathway.

8. The flexible circuit of claim 1, wherein the temperature sensor is embedded within the flexible body.

9. The flexible circuit of claim 1, wherein the temperature sensing circuit comprises an insulative barrier coupled to the conductive pathway.

10. A removable card connector assembly comprising:
a circuit board;
a connector coupled to the circuit board and configured to couple the assembly to another circuit board; and
a flexible circuit to electrically couple the circuit boards, the flexible circuit comprising:
opposite first and second circuit board mating ends and a flexible body extending therebetween;
conductive pathways extending along the body of the flexible circuit to electrically couple the circuit boards; and
a temperature sensing circuit comprising leads having a distal end coupled to a temperature sensor and a temperature contact located proximate to one of circuit board mating ends, the temperature sensor located at an intermediate position along the body between the circuit board mating ends, the temperature contact configured to deliver temperature signals that are distinct and independent from a temperature of the circuit boards.

11. The flexible circuit of claim 10, wherein the temperature sensing circuit comprises an insulative barrier coupled to the conductive pathway.

12. The flexible circuit of claim 10, wherein the temperature sensor is embedded within the flexible body.

13. The flexible circuit of claim 10, wherein the temperature sensor is coupled to a surface of the flexible substrate.

14. The flexible circuit of claim 10, wherein the temperature sensor is at least one of a thermocouple and a resistive thermal device.

15. The flexible circuit of claim 10, wherein a first temperature sensing circuit has a temperature contact located proximate the first circuit board mating end and a second temperature sensing circuit has a temperature contact located proximate the second circuit board mating end.

16. The flexible circuit of claim 10, wherein the temperature signals represent at least one of a trace temperature, a body temperature, or a surrounding temperature.

17. An electrical system comprising:
circuit boards;
a connector configured to couple the circuit boards;
a flexible circuit to electrically couple the circuit boards; and
a temperature sensing circuit comprising leads having a distal end coupled to a temperature sensor and a temperature contact located proximate to an end of the flexible circuit, the temperature sensor located at an intermediate position along the flexible circuit between ends of the flexible circuit, the temperature contact configured to deliver temperature signals from the temperature sensor representative of a local temperature.

18. The electrical system of claim 17, wherein the temperature sensor is positioned adjacent a conductive pathway of the flexible circuit.

19. The electrical system of claim 17, wherein the temperature signals represent at least one of a trace temperature, a body temperature, or a surrounding temperature.

20. The electrical system of claim 17, wherein the temperature sensor is at least one of a thermocouple and a resistive thermal device.
